(19) United States
(12) Patent Application Publication
(10) Pub. No.: US 2007/0174896 A1
(43) Pub. Date: Jul. 26, 2007

(54) Security policy assignment apparatus and method and storage medium stored with security policy assignment program

(76) Inventors: Hiroshi Furuya, Kawasaki-shi (JP); Takanobu Suzuki, Kawasaki-shi (JP); Hiromi Ohara, Kawasaki-shi (JP); Takayuki Kubodera, Kawasaki-shi (JP); Yutaka Agawa, Ebina-shi (JP)

Correspondence Address: GAUTHIER & CONNORS, LLP, 225 FRANKLIN STREET, SUITE 2300, BOSTON, MA, 02110, US

(21) Appl. No.: 11/482,127

(22) Filed: Jul. 6, 2006

(30) Foreign Application Priority Data
Jan. 25, 2006 (JP) 2006-16188

(51) Int. Cl. H04L 9/00

(52) U.S. Cl. 726/1

(57) ABSTRACT

A security policy assignment apparatus includes an acquisition unit that acquires key data from a set field in a digital document or its associated data and an assignment unit that assigns a security policy, which has been set with a set value corresponding to the acquired key data, to the digital document by referencing correspondence information that maps the key data and the set value of the security policy.

### BACKGROUND

1. Technical Field

The present invention relates to a technology for assigning a security policy to a digital document.

2. Related Art

As the network environment develops in recent years, the digitizing of documents for a paperless-office is progressing. For example, when transmitting information in an office, a digital document is created on a PC (personal computer) and distributed.

However, offices even now have large quantities of paper documents that have not been digitized as well as digital documents that have not been assigned a security policy.

### SUMMARY

According to an aspect of the invention, a security policy assignment apparatus includes an acquisition unit that acquires key data from a set field in a digital document or associated data thereto and an assignment unit that assigns a security policy, which has been set with a set value corresponding to the acquired key data, to the digital document by referencing correspondence information that maps the key data and the set value of the security policy.

### BRIEF DESCRIPTION OF THE DRAWINGS

Embodiments of the present invention will be described in detail based on the following figures, wherein:

FIG. 1 schematically shows a configuration example of a policy assignment system;

FIG. 2 is a sequence chart showing the flow of processing when a paper document is scanned;

FIG. 3 is a sequence chart showing the flow of processing for an existing digital document;

FIG. 4 shows an example of a setup sheet;

FIG. 5 shows an example of another setup sheet;

FIG. 6 shows an example of a digital document;

FIG. 7 is a correspondence table for determining the security policy from policy information;

FIG. 8 is a flowchart showing the flow of processing when using the setup sheet;

FIG. 9 is a flowchart showing the flow of processing when not using the setup sheet; and

FIG. 10 is a flowchart showing the flow of processing for an existing digital document.

### DETAILED DESCRIPTION

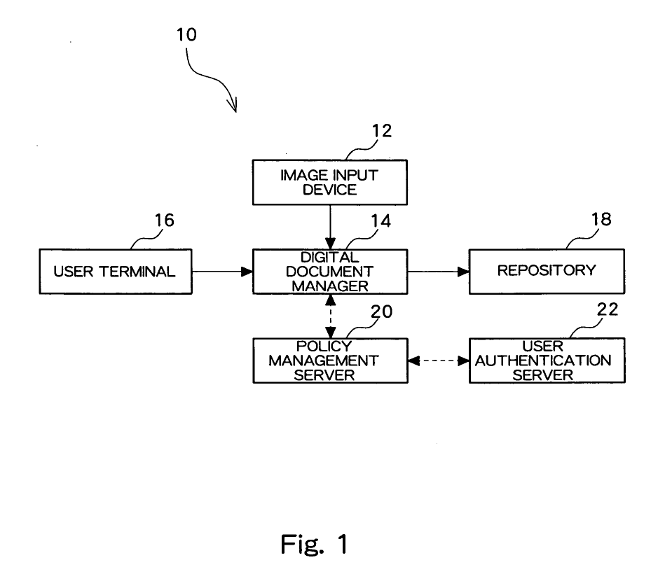

FIG. 1 is a block diagram schematically showing a configuration of a policy assignment system 10 relating to an embodiment. The policy assignment system 10 performs assignment and management of a security policy for a digital document. The policy assignment system 10 includes an image input device 12, a digital document manager 14, a user terminal 16, a repository 18, a policy management server 20, and a user authentication server 22. These components may be constructed as an integrated processing system within a single device or as a distributed processing system that is connected, for example, through a network.

The image input device 12 generates a digital document (typically a digital image created in a raster format) from a paper document and is constructed, for example, from a scanner or a multifunction device (equipped with scanner, printer, and facsimile functions). The image input device 12 generates a digital document from a paper document and transmits the digital document to the digital document manager 14. In the stage where the digital document is generated, the digital document is not usually set with a security policy.

The digital document manager 14 is the core of the policy assignment system 10 and is equipped with functions, such as a function for assigning a security policy and a function for managing digital documents according to the security policy. Functions provided in the digital document manager 14 for assigning a security policy include a function for acquiring policy information from within a digital document to be a keyword for setting the security policy, a function for determining a security policy on the basis of information to map policy information and a security policy set value, and a function for encrypting the digital document on the basis of the determined security policy. Furthermore, as a management function based on the security policy, a function is included to judge whether to allow access by issuing an inquiry to the policy management server 20 with regard to a user's operating privilege on the basis of the security policy when there is an access request to a digital document. To implement this function, the digital document manager 14 is constructed from a computer that includes hardware with arithmetic and control functions and software for defining their operations, such as a PC (personal computer) and a multifunction device that may or may not be identical to the image input device 12. The digital document manager 14 is connected to the image input device 12 and inputs digital documents and user commands from the image input device 12. Furthermore, the digital document manager 14 is also connected to the user terminal 16 and inputs user commands via the user terminal 16.

On the basis of user operations, the user terminal 16 issues commands to the digital document manager 14 for the generation, storage, and printing of digital documents. The user can issue a command via the user terminal 16 to set a security policy for a digital document that has already been stored in the repository 18 and not been set with a security policy. The user terminal 16 can be constructed from various devices on a network, such as a PC or a multifunction device.

The repository 18 is a device for storing digital documents before or after the digital document manager 14 has assigned a security policy. A digital document that has been assigned a security policy may be encrypted so as not to be manipulated by a third party. The repository 18 can be constructed by using a storage area that is accessible from the digital document manager 14. Specific examples of a storage area include a file server connected to the digital document manager 14, a local storage of the image input device 12, a local storage of the user terminal 16, a file server on the Internet, a P2P (Peer to Peer) shared file area, and so forth.

The policy management server 20 is positioned to be accessible from the digital document manager 14 and manages the security policy that has been assigned to a digital document. A security policy determines the limits of various operating privileges with respect to a digital document, such as display, editing, copying, and printing, and can be set for every digital document and for every user. The security policy that is set by the policy management server 20 includes storage location and identification information of each digital document as well as information on user operating privileges for each type of operation. Furthermore, as necessary, also included is information specifying the operation that was performed to protect a digital document, such as encryption information for the digital document.

The user authentication server 22 is positioned to be accessible from the policy management server 20 and authenticates a user who is logging in or performing an operation with respect to the policy assignment system 10. If the policy assignment system 10 forms a distributed system, user authentication at each device or component can be performed in a batch process by using the user authentication server 22.

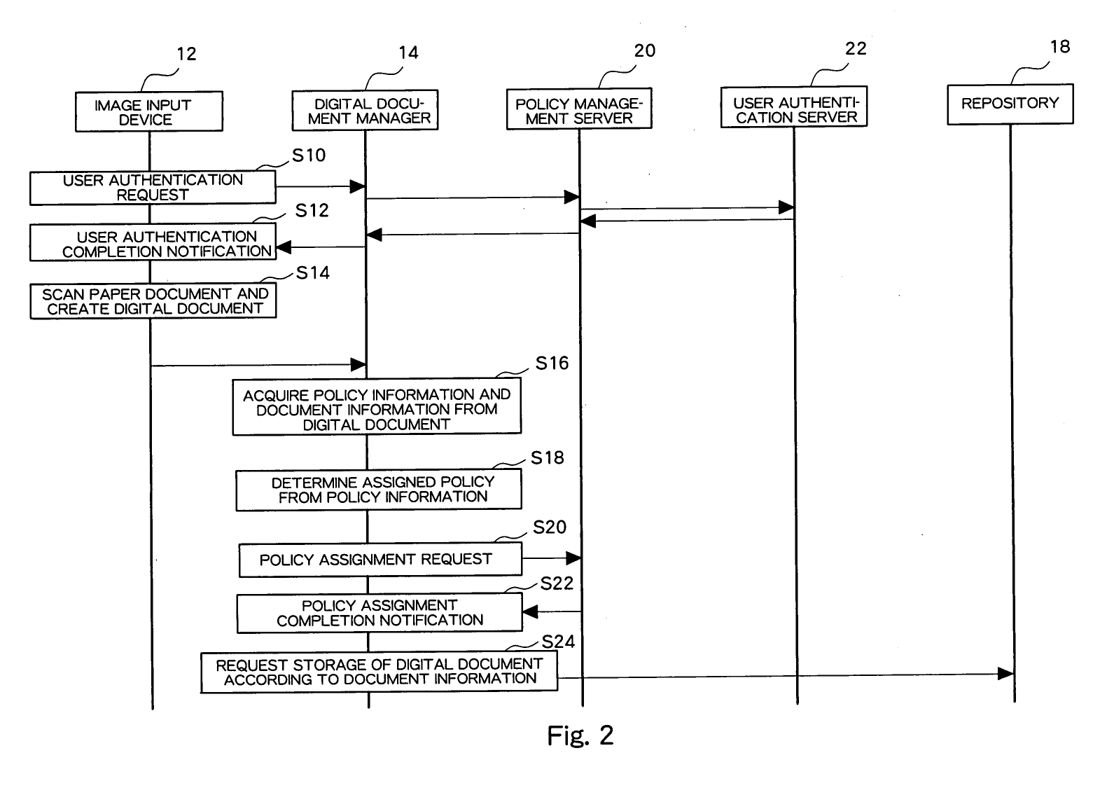

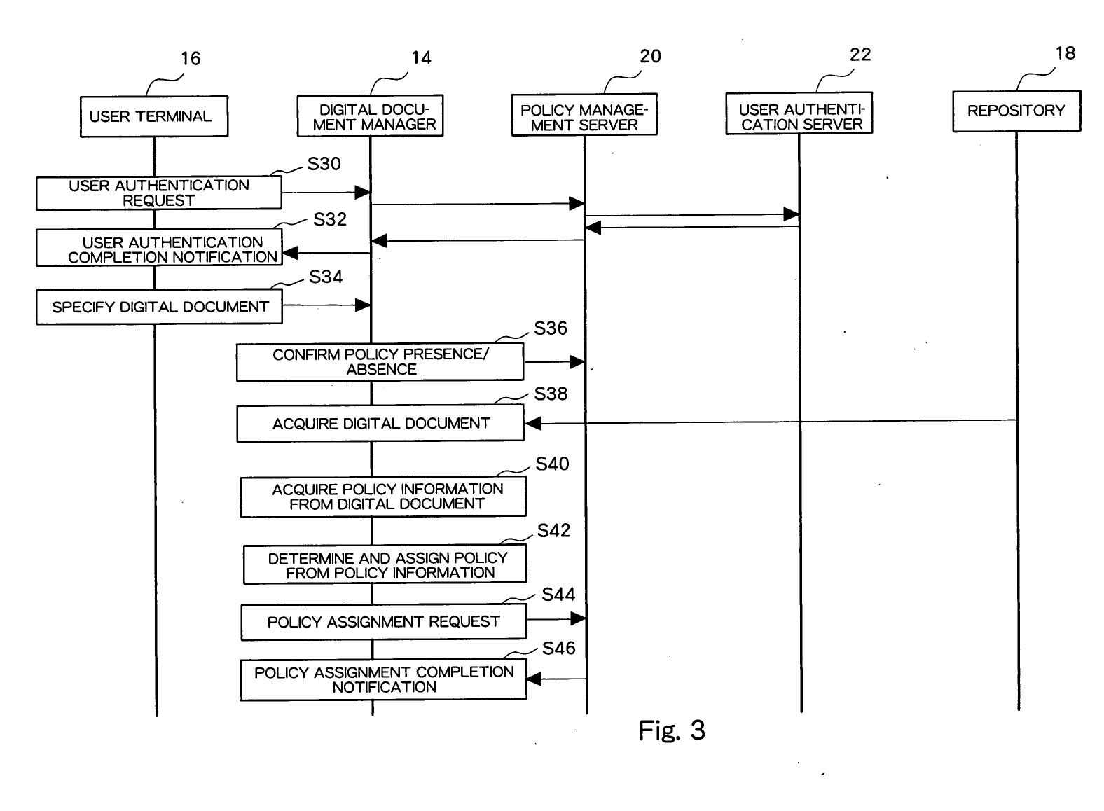

Next, an operation of the policy assignment system of FIG. 1 will be described using the UML (Unified Modeling Language) sequence charts of FIG. 2 and FIG. 3.

FIG. 2 describes the flow of processing when a paper document is scanned to generate a digital document and a security policy is assigned to the digital document. In this case, a user attempts to log in by entering a user name and password from the operating panel of the image input device 12. Then, the entered user name and password information is sent from the image input device 12 to the user authentication server 22 via the digital document manager 14 and the policy management server 20 and authenticated (S10) by the user authentication server 22. The authenticated information is transferred to the image input device 12 via the policy management server 20 and the digital document manager 14 and displayed on the operating panel.

The user next places the paper document on the image input device 12 and performs scanning. At this time, a command to assign a security policy to the generated digital document is also issued due to a standard setting or user command. At the image input device 12, the paper document is scanned and a digital document is created (S14) and transmitted to the digital document manager 14.

At the digital document manager 14, policy information and document information are acquired (S16) from the acquired digital document. The policy information includes data to be keywords for setting the security policy and its acquisition can be performed from characters or images forming the digital document, metadata of the digital document, characters or images forming another digital document generated from scanning and mapping the digital document with prior and subsequent digital documents, and so forth. The policy information is normally taken from a predetermined part of such a digital document in accordance with a rule set in advance. Furthermore, the document information includes information necessary for the storage of the digital document, such as storage destination and storage document name. Although the document information is typically acquired on the basis of a user command that is input from the image input device 12, it can, for example, also be read from the digital document in the same manner as the policy information.

The digital document manager 14 determines (S18) the setting for the security policy to be assigned from the acquired policy information in accordance with the correspondence relation that has been set in advance. Then, a command is issued (S20) with respect to the policy management server 20 to set the determined security policy to the digital document. At the policy management server 20, the security policy is stored with the document information of the digital document and a report thereof is issued to the digital document manager 14. Furthermore, the digital document manager 14 encrypts the digital document as necessary, and then stores the digital document into the repository 18 in accordance with the document information.

In this manner, the conversion of a paper document into a digital document and the setting of a security policy for the digital document are performed. In this mode, once a rule for security setting has been determined, the user can create a large quantity of digital documents that have been set with a security policy without having to be particularly conscious about setting a security policy. Therefore, for example, a large quantity of paper documents in an office can be easily quickly and easily converted into digital documents.

Next, a modification of the example shown in FIG. 2 will be described using FIG. 3. FIG. 3 shows the flow of processing when setting a security policy for a digital document that is stored in the repository 18.

In this example, the user operates the user terminal 16 and attempts to log in to the digital document manager 14. The digital document manager 14 sends a request (S30) for user authentication to the user authentication server 22 via the policy management server 20 and the user authentication result is transmitted (S32) to the user terminal 16 via the digital document manager 14.

A digital document to be set with a security policy is specified (S34) from the user terminal 16 for the digital document manager 14. The digital document manager 14 sends an inquiry to the policy management server 20 to confirm that a security policy has not been assigned (S36) after which this digital document is acquired (S38) from the repository 18. Although it is possible to reset the security policy if it has already been set, this must at least be performed so as not to contradict the security policy that has already been set.

The digital document manager 14 acquires policy information from the entered digital document (S40), and after determining (S42) the security policy corresponding to the policy information, issues a request for security policy assignment to the policy management server 20. The policy management server 20 then sets the security policy and notifies the digital document manager 14 of this. The digital document manager 14 encrypts the digital document that is stored in the repository 18 as necessary.

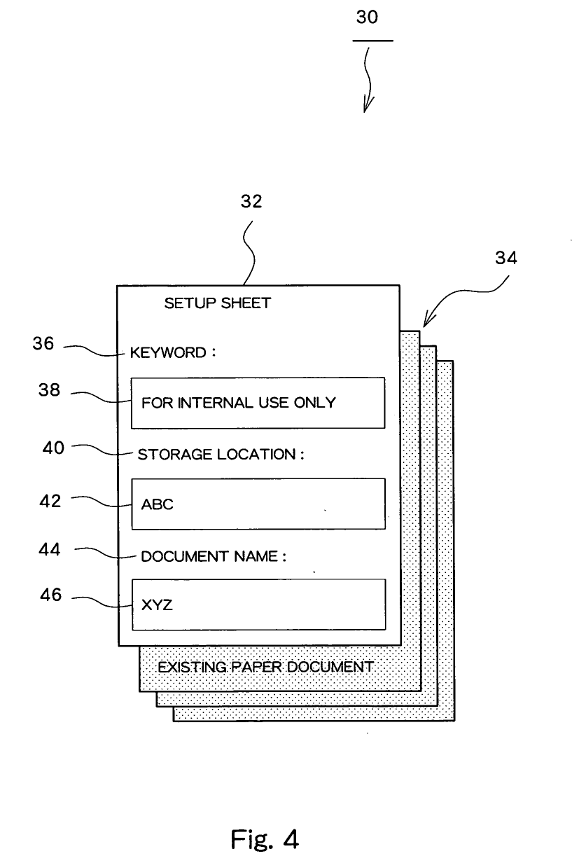

Several modes for setting policy information will be described next using FIG. 4 through FIG. 6.

When a paper document is scanned, FIG. 4 illustrates an example of setting policy information through another document (called a setup sheet) to be scanned simultaneously with the paper document. A paper document 30 formed from multiple sheets to be scanned is shown in FIG. 4. The paper document 30 is formed from a setup sheet 32 placed at the very top and a paper document 34 to be stored.

The setup sheet 32 is provided with fields to be filled predetermined entries. More specifically, the setup sheet 32 has a keyword field 36 with a value 38 of “for internal use only”, a storage location field 40 with a value 42 of “ABC”, and a document name field 44 with a value 46 of “XYZ”. The setup sheet 32 is usually created using a word processor in a standardized form. However, if the fields are filled so as not to interfere with scanning, such as if the field entries are clear and properly positioned, the values 38, 42, 46 and the fields 36, 40, 44 may be handwritten instead.

The setup sheet 32 is scanned together with the underlying paper document 34. After being converted to a digital document, the digital document manager 14 performs matching with setup sheet data that was set in advance. As a result, it can be seen from the setup sheet 32 that the created digital document is included and further that the digital document is a setup sheet for the digital document created that was from the paper document 34. Then, repository information is read from the value 38 of the keyword field 36 and document information is read from the value 42 of the storage location field 40 and the value 46 of the document name field 44. In this process, pattern matching technology is employed, such as optical character recognition (OCR) or pattern recognition.

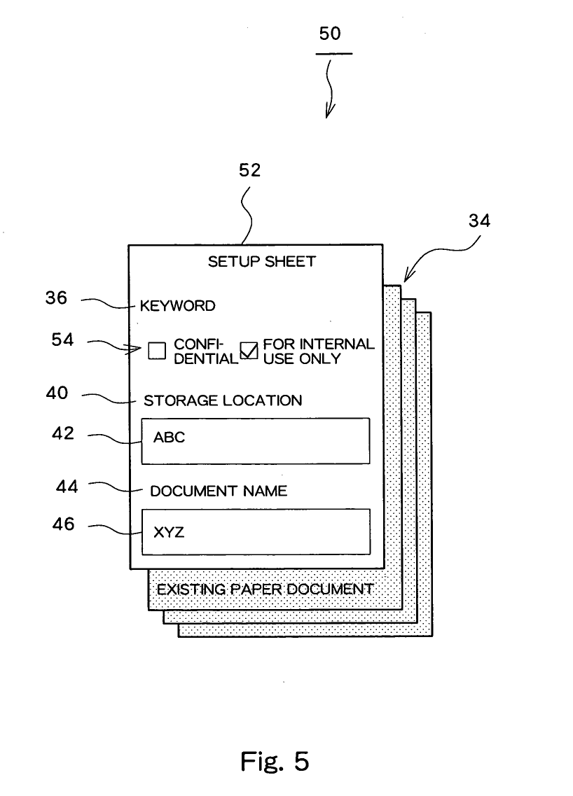

FIG. 5 illustrates a modified example using a setup sheet. Components identical to the components in FIG. 4 are designated like reference characters and their descriptions are simplified. In a paper document 50 that is shown, a setup sheet 52 replaces the setup sheet 32 shown in FIG. 4. In the setup sheet 52, instead of the value 38 of the keyword field 36, a value 54 is entered using a check box format. The check box format has advantages of simplifying handwritten inputs and increasing the scanning accuracy even with handwritten inputs.

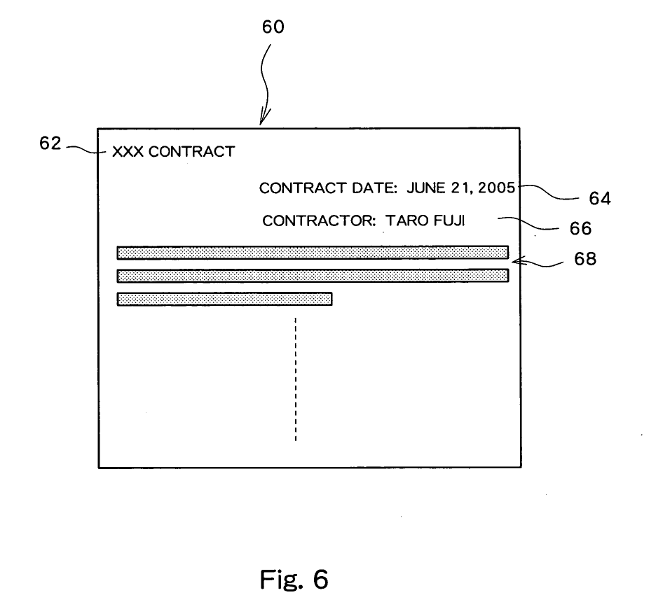

FIG. 6 illustrates an example of setting policy information directly from a digital document to which a security policy is to be assigned without using a setup sheet. This mode is particularly convenient when the preparation of the setup sheet is troublesome or when the digital document has standardized entries that can be easily scanned. In a document 60 shown in FIG. 6, from the top is a title field 62 filled in with “XXX Contract”, a contract date field 64 filled in with “Jun. 21, 2005”, and a contractor field 66 filled in with “Taro Fuji, under which is a general sentence 68.

The title field 62, the contract date field 64, and the contractor 66 are fields usually provided on a contract and are filled in at approximately fixed positions using a standardized form. Thus, these fields are easily scanned and can be expected to always yield the same type of entries. In this example, the entry for the title field 62 is set with a keyword (policy information) to assign a security policy, the entry for the contract date field 64 is set with storage location information for the digital document to be sorted by year, and the contractor field 66 is set with document name information to be added to the digital document. As a result, information identical to that in the examples shown in FIG. 4 and FIG. 5 can be acquired without the use of a setup sheet.

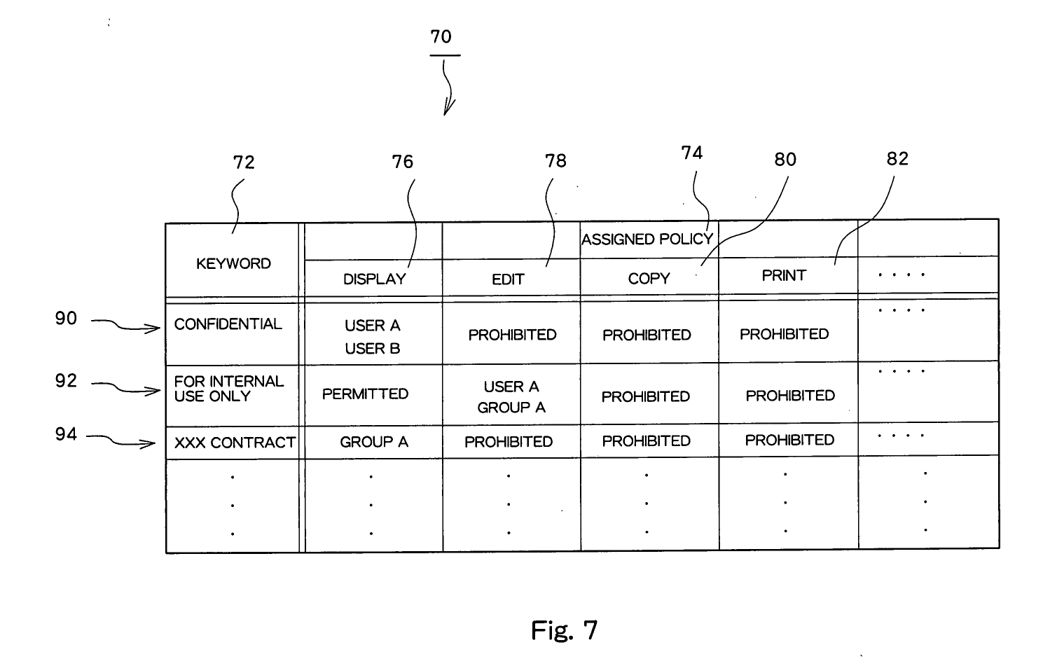

FIG. 7 shows an example of correspondence information for assigning a security policy from the policy information that describes the acquisition method using FIG. 4 through FIG. 6. In the figure, the correspondence information is recorded as a correspondence table 70. The correspondence table 70 is provided with a keyword field 72 for representing policy information and an assigned policy field 74 for representing a corresponding set value. The assigned policy field 74 is then subdivided into a display field 76, an edit field 78, a copy field 80, and a print field 82 for representing various operations.

In a line indicated by a code 90, a security policy set value is displayed for the case where “confidential” has been set in the keyword field 72. More specifically, a security policy has been set to permit the execution of display operations only by “user A” and “user B” and to prohibit the execution of editing, copying, and printing operations by all users. Similarly, according to a line indicated by a code 92, in the case where “for internal use only” has been set for the policy information, a security policy has been set to permit the execution of display operations by all users, to permit the execution of editing operations only by “user A” and “group A” and to prohibit the execution of copying and printing operations by all users. Furthermore, according to a line indicated by a code 94, in the case where “XXX Contract” has been set for the policy information, a security policy has been set to permit the execution of display operations by “group A” and to prohibit the execution of editing, copying, and printing operations by all users.

The digital document manager 14 is set in advance with the correspondence table 70. Then, when setting the security policy, the digital document manager 14 searches the keyword field 72 of the correspondence table 70 for the acquired policy information as the keyword and reads the corresponding value. The creation of the correspondence table 70 is usually performed on the basis of user command. However, to lighten the burden on the user, for example, the provision of an automatic creation function can be considered to be effective, where the set mode of the digital document that has already been set with a security policy is analyzed to yield a setting rule which is proposed to the user.

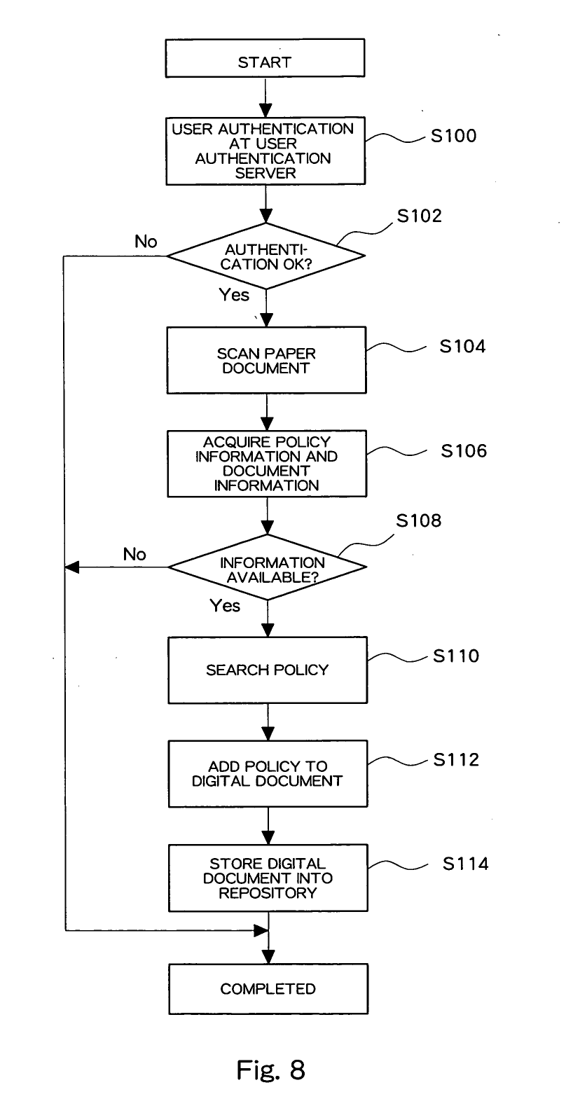

Finally, the flow of processing in the setting of a security policy will be described using the flowcharts in FIG. 8 through FIG. 10.

FIG. 8 is a flowchart showing an example of setting a security policy on the basis of policy information acquired from a setup sheet. In this case, the user first attempts to log in from the image input device 12 and undergoes user authentication (S100) in the user authentication server 22. User authentication can be implemented, for example, by using an LDAP (Lightweight Directory Access Protocol) server. If, as a result of the authentication (S102), the authentication fails, the processing stops, and if the authentication succeeds, continuation of the processing is allowed. In the latter case, the user issues a command (S104) to the image input device 12 to scan a paper document. At this time, a setup sheet is attached to the top of the paper document.

As a result of the scan, the resulting digital document is sent to the digital document manager 14 and the digital document manager 14 analyzes (S106) the top page to acquire policy information and document information. As a result, if policy information and document information are not indicated on the setup sheet, the processing stops, and if they are indicated, the correspondence table is searched (S110) with the policy information as the keyword. Next, the digital document manager 14 creates a security policy, which has an obtained set value, maps it to the digital document, and registers it into the policy management server 20 (S112). Then, the digital document is encrypted with a public key of a user having operating privileges and a unique document ID and information of the policy management server 20 are assigned to the digital document after which the digital document is stored into the repository 18. The storage location is selected on the basis of the document information that was acquired in step S106.

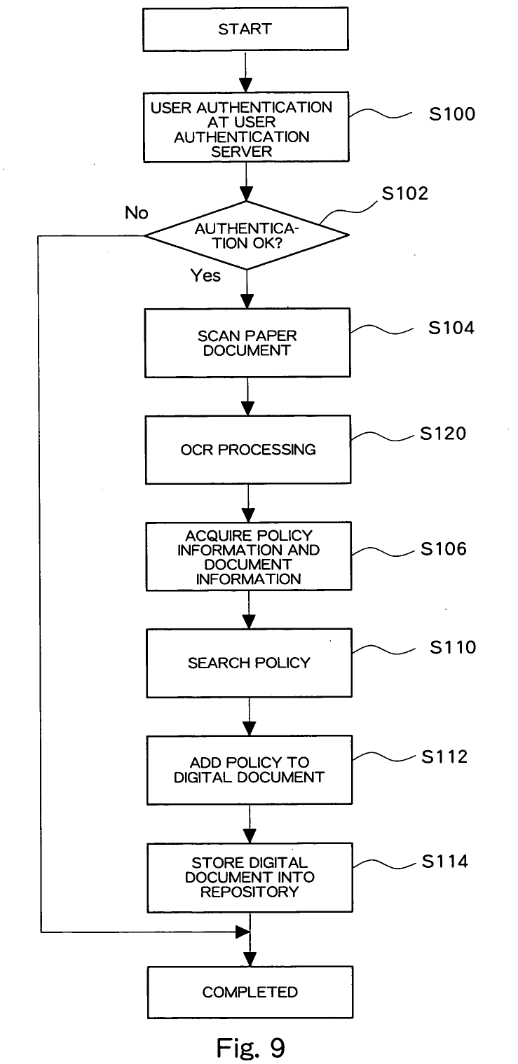

Next, using FIG. 9, the flow of processing will be described when setting a security policy on the basis of the content of a digital document created from scanning without using a setup sheet. In the flowchart that is shown, processes identical to those in FIG. 8 are designated like reference characters and their descriptions are simplified.

In this mode, the processing from the scanning of the paper document until the generation of the digital document (S100 to S104) is performed in the same manner as in FIG. 8. However, in this case, a setup sheet is not attached to the top of the paper document and an OCR process is performed (S120) directly on the digital document that is created from scanning. The policy information and document information acquired as a result of the OCR process are identical to the example shown in FIG. 8. Thereafter, a security policy setting is performed (S106 to S114) in the same manner as in the example of FIG. 8.

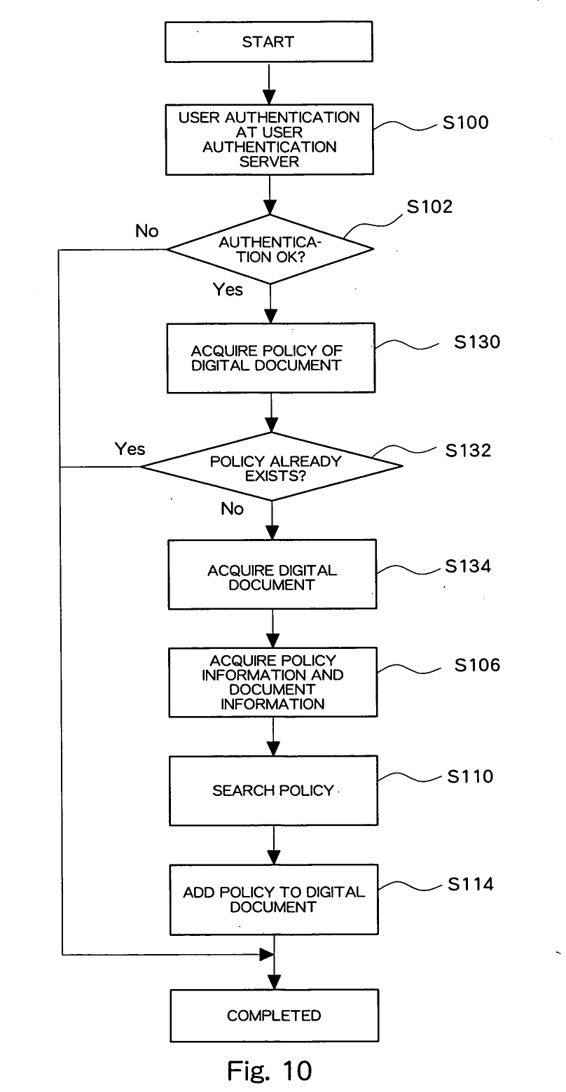

Next, using FIG. 10, a mode will be described for acquiring policy information from a digital document that has already been stored and setting a security policy. In the flowchart that is shown, processes identical to those in FIG. 8 are designated like reference characters and their descriptions are simplified.

In this processing, after user authentication is performed (S100, S102), the digital document to be processed is selected. Then, acquisition of a corresponding security policy from the policy management server 20 is attempted (S130) and its presence or absence is judged (S132). As a result, if a security policy has already been set, the processing ends, and if it has not been set, the digital document is acquired (S134) from the repository 18. Thereafter, policy information and document information are acquired from the acquired digital document and the processing for setting the security policy is fundamentally identical to the examples shown in FIG. 8 and FIG. 9 (S106 to S114). However, it is not necessary to store the digital document once more and an encryption process is performed as necessary on the digital document that is already stored.

The aforementioned examples showed modes where a security policy is set for one paper document or digital document. However, a security policy can also be set for multiple paper documents or digital documents in the same manner. In this case, it is not necessary for the user to perform the setting for each paper document or digital document and the various security policy settings can be performed in a batch process so as to substantially decrease the burden on the user.

Various embodiments are summarized hereinafter. Some embodiments may overlap with the aforementioned descriptions.

The security policy assignment apparatus can be constructed using hardware with arithmetic functions and software for defining their operations. The security policy assignment apparatus may be constructed as an apparatus formed from a single chassis or as an apparatus formed from multiple chassis capable of communications.

The acquisition unit acquires key data from a set field that is set in a digital document or from a set field that is set in data associated with the digital document. The digital document refers to electronically generated data and to an expression of a document formed from characters or figures or photographs. The digital document may be formed from one sheet page or multiple sheet pages in a print image. If the digital document is formed from multiple sheets, all the pages are usually gathered into one file. Furthermore, the data associated with the digital document refers to the data besides the digital document and to data mapped to the digital document, such as an attached digital document that is handled together with the digital document. The set field that is set in the digital document or the associated data refers to an area or entry that has been defined to acquire key data, such as by a user preset. The location and size (in the print image) of the set field may be fixed or variable. Key data refers to one or multiple data to be extracted from the set field and used as a key to set a security policy.

The assignment unit sets a security policy to a digital document. During the setting process, correspondence information prepared in advance is referenced. The correspondence information maps key data and the set value of the security policy. The security policy here refers to management information defining the operating privileges for a digital document. Furthermore, the operating privileges refer to the operations that can be performed with respect to a digital document, such as reading, writing, printing, transmitting, and so forth. The security policy can be set for every digital document or can be set for every user or user group. Thus, when setting the security policy, it is generally necessary to permit or prohibit multiple privileges for multiple users. These specific values are referred to here as the set values of the security policy. The key data is mapped in the correspondence information to one or multiple set values. The assignment unit sets the set value that is determined by the key data as the security policy and assigns it to the digital document. The assignment of the security policy is performed so as to ensure the effectiveness of the operating privileges in accordance with the security policy. This can be set in various ways. For example, modes can be illustrated where only those with privileges can perform encryption that can be decrypted or only those with privileges can provide a passable gate.

According to this mode, provided the user defines the set field in advance as necessary and sets the correspondence information, the security policy for a digital document (or its original paper document) can be set without the user necessarily performing any subsequent special operation (although an operation, such as confirmation, can be performed as necessary). In particular, when setting the security policy for large quantities of digital documents, the task burden is reduced. The security policy assignment apparatus usually performs processing for digital documents that have not been assigned with a security policy. However, for example, the apparatus may be designed to reset the security policy for digital documents that have already been assigned.

In one mode of the security policy assignment apparatus of the present invention, a scanning unit is included to scan a paper document and generate a digital document. The digital document relating to the acquisition unit is a digital document generated by the scanning unit. Typically, the scanning unit is implemented by a scanner. The scanner itself may occupy a single chassis or form a part of a multifunction device or a copying machine. In the latter case, integrating the acquisition unit or the assignment unit into the multifunction device or the copying machine is also effective.

In one mode of the security policy assignment apparatus of the present invention, the scanning unit generates associated data by scanning another paper document mapped to the paper document and including a standardized entry and the scanning unit acquires the key data from the set field that is set for the standardized entry in the associated data. The standardized entry refers to an entry having a predictable or recognizable rule. More specifically, a mode in which the same entry fields are always prepared or a mode in which a selection is always made from multiple choices can be illustrated. According to this configuration, besides the paper document that becomes the digital document, the paper document (or setup sheet) having information that becomes the key data in a standardized entry can be scanned by the scanning unit. These two paper documents are mapped by stacking and scanning them in sequence and assigning a common identification number.

In one mode of the security policy assignment apparatus of the present invention, the associated data includes data indicating a user who issued a scan command to the scanning unit or data indicating the time when the scanning unit generated the digital document and the scanning unit acquires the key data from the set field that includes data indicating the time or data indicating the user in the associated data. Namely, the security policy setting is performed while taking into consideration the user relating to the command and the document creation time stamp.

In one mode of the security policy assignment apparatus of the present invention, the digital document relating to the acquisition unit is a digital document that is stored without being assigned a security policy. Namely, among the digital documents that are already stored, the security policy setting is performed for those digital documents that have not been assigned a security policy.

In one mode of the security policy assignment apparatus of the present invention, the digital document includes standardized data and the acquisition unit acquires the key data from the set field that is set for standardized data in the digital document. Namely, the key data is acquired from the standardized part in the digital document itself.

In one mode of the security policy assignment apparatus of the present invention, the standardized data included in the digital document is metadata concerning the digital document. Furthermore, in one mode of the security policy assignment apparatus of the present invention, the standardized data included in the digital document is text data or image data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A security policy assignment apparatus comprising:
an acquisition unit that acquires key data from a set field in a digital document or associated data thereto; and
an assignment unit that assigns a security policy, which has been set with a set value corresponding to the acquired key data, to the digital document by referencing correspondence information that maps the key data and the set value of the security policy.

2. A security policy assignment apparatus according to claim 1, further comprising:
a scanning unit that scans a paper document and generates a digital document;
the digital document obtained from the acquisition unit is generated by the scanning unit.

3. A security policy assignment apparatus according to claim 2, wherein:
the scanning unit generates the associated data by scanning another paper document mapped to the paper document and including a standardized entry; and
the scanning unit acquires the key data from the set field that is set for the standardized entry in the associated data.

4. A security policy assignment apparatus according to claim 2, wherein:
the associated data includes data indicating a user who issued a scan command to the scanning unit or data indicating the time when the scanning unit generated the digital document; and
the scanning unit acquires the key data from the set field that includes data indicating the time or data indicating the user in the associated data.

5. A security policy assignment apparatus according to claim 1, wherein:
the digital document relating to the acquisition unit is a digital document that is stored without being assigned a security policy.

6. A security policy assignment apparatus according to claim 1, wherein:
the digital document includes standardized data; and
the scanning unit acquires the key data from the set field that is set for standardized data in the digital document.

7. A security policy assignment apparatus according to claim 6, wherein:
the standardized data included in the digital document is metadata concerning the digital document.

8. A security policy assignment apparatus according to claim 6, wherein:
the standardized data included in the digital document is text data or image data.

9. A storage medium readable by computer, the storage medium storing a program of instructions executable by the computer to perform a security policy assignment process, the process comprising the steps of:
acquiring key data from a set field in a digital document or associated data thereto; and
assigning a security policy, which has been set with a set value corresponding to the acquired key data, to the digital document by referencing correspondence information that maps the key data and the set value of the security policy.

10. A storage medium according to claim 9, the process further comprising the step of:
scanning a paper document to generate the digital document.

11. A storage medium according to claim 10, the process further comprising the steps of:
generating the associated data by scanning another paper document mapped to the paper document and including a standardized entry; and
acquiring the key data from the set field that is set for the standardized entry in the associated data.

12. A storage medium according to claim 10, wherein:
the associated data includes data indicating a user who issued a scan command to the scanning unit or data indicating the time when the scanning unit generated the digital document; and
in the process, the key data is acquired from the set field that includes data indicating the time or data indicating the user in the associated data.

13. A storage medium according to claim 9, wherein:
the digital document is a digital document that is stored without being assigned a security policy.

14. A storage medium according to claim 9, wherein:
the digital document includes standardized data; and
in the process, the key data is acquired from the set field that is set for standardized data in the digital document.

15. A security policy assignment method, the method comprising the steps of:
acquiring key data from a set field in a digital document or associated data thereto; and
assigning a security policy, which has been set with a set value corresponding to the acquired key data, to the digital document by referencing correspondence information that maps the key data and the set value of the security policy.

16. A security policy assignment method according to claim 15, the method further comprising the step of:
scanning a paper document to generate the digital document.

17. A security policy assignment method according to claim 16, the method further comprising the steps of:
generating the associated data by scanning another paper document mapped to the paper document and including a standardized entry; and
acquiring the key data from the set field that is set for the standardized entry in the associated data.

18. A security policy assignment method according to claim 16, wherein:
the associated data includes data indicating a user who issued a scan command to the scanning unit or data indicating the time when the scanning unit generated the digital document; and
the key data is acquired from the set field that includes data indicating the time or data indicating the user in the associated data.

19. A security policy assignment method according to claim 15, wherein:
the digital document is a digital document that has been stored without being assigned a security policy.

20. A security policy assignment method according to claim 15, wherein:
the digital document includes standardized data;
the key data is acquired from the set field that is set for standardized data in the digital document.
